(19) United States
(12) Patent Application Publication
(10) Pub. No.: US 2026/0071021 A1
(43) Pub. Date: Mar. 12, 2026

(54) PRODUCTION OF POLYURETHANE FOAM

(71) Applicant: Evonik Operations GmbH, Essen (DE)

(72) Inventors: Sarah OTTO, Essen (DE); Michael SUCHAN, Gelsenkirchen (DE)

(73) Assignee: Evonik Operations GmbH, Essen (DE)

(21) Appl. No.: 19/106,417

(22) PCT Filed: Aug. 28, 2023
(86) PCT No.: PCT/EP2023/073496

§ 371 Date: Feb. 25, 2025

(30) Foreign Application Priority Data
Aug. 31, 2022 (EP) 22193056.3

(51) Int. Cl. C08G 18/08; C08G 18/20; C08G 18/42; C08G 101/00; C08J 9/14; C08K 3/26; C08K 7/00

(52) U.S. Cl. CPC C08G 18/14; C08G 18/0866; C08G 18/2027; C08G 18/4211; C08J 9/141; C08K 3/26; C08K 7/00; C08G 2101/00; C08G 2110/0025; C08G 2110/005; C08G 2110/0058; C08G 2110/0066; C08J 2203/14; C08J 2205/10; C08J 2375/06; C08K 2003/265; C08K 2201/003; C08K 2201/019

(57) ABSTRACT

Composition for producing polyurethane, preferably PU foam, especially rigid PU foam, comprising a polyisocyanate component, a polyol component, optionally blowing agents, at least one solid filler, optionally at least one catalyst that catalyses the formation of a urethane or isocyanurate linkage, wherein the composition comprises at least one surfactant based on a quaternary ammonium compound.

The present invention relates to the field of polyurethanes, in particular that of polyurethane foams. In particular, it relates to the production of polyurethane foams using solid fillers and surfactants based on quaternary ammonium compounds such as ester quats and/or alkyl quats, to compositions for the production of such foams, and also to the use of said foams.

Polyurethane (PU) in the context of the present invention is in particular understood to mean a product obtainable through reaction of polyisocyanates and polyols or compounds having isocyanate-reactive groups. In addition to the polyurethane, further functional groups may also be formed here, for example uretdiones, carbodiimides, isocyanurates, allophanates, biurets, ureas and/or uretonimines. For the purposes of the present invention, PU is therefore understood to mean not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is understood to mean foam that is obtained as a reaction product based on polyisocyanates and polyols or compounds having isocyanate-reactive groups. In addition to the eponymous polyurethane, further functional groups may also be formed here, for example allophanates, biurets, ureas, carbodiimides, uretdiones, isocyanurates or uretonimines. The terms “foam” and “foam material” are used synonymously in the context of the present invention.

In connection with the provision of PU, preferably PU foams, especially PU rigid foams, it is a particularly important concern to produce these in a particularly cost-effective manner. A further concern is to produce these in a particularly sustainable manner, for example by using bio-based and/or recycled materials. Also for this reason, different solids may also be used when providing PU. In the known prior art, appropriate solids are described that are suitable for use in PU.

However, the use of solids usually gives rise to considerable problems with regard to dispersion in the liquid feedstocks and processing. These include inter alia sedimentation, difficult redispersion after sedimentation, inhomogeneous distribution in the PU and, especially, a consequent inhomogeneous property profile in the polyurethanes thus produced. There have been efforts to use dispersing additives to overcome these problems, but so far without really convincing results. Among other things, the use of dispersing additives has each time been accompanied by a sharp increase in the viscosity of the components, making processing significantly more difficult or even impossible.

Against this background, the specific problem addressed by the present invention was that of making it possible to provide PU that comprise solid fillers, but overcome the aforementioned problems of sedimentation, difficult redispersion after sedimentation and inhomogeneous distribution in the material, in particular avoiding an excessive increase in the viscosity of the components.

In this regard, it was surprisingly found in the context of the present invention that the use of surfactants based on quaternary ammonium compounds, such as ester quats and/or alkyl quats, enables the desired significant improvement in redispersion, sedimentation stability and also a more homogeneous property profile of the material. The viscosity of the components is here influenced only to a significantly lesser degree.

The abovementioned problem is solved by the subject matter of the invention. The invention provides a composition for producing PU, preferably PU foam, especially rigid PU foam, comprising a polyisocyanate component, a polyol component, optionally blowing agents, at least one solid filler, optionally at least one catalyst that catalyses the formation of a urethane or isocyanurate linkage, the composition comprising at least one surfactant based on quaternary ammonium compounds, preferably based on a silicon-free quaternary ammonium compound, such as preferably ester quat, alkyl quat, amidoamine quat and/or imidazolinium quat.

For the purposes of the present invention, “solid” filler is intended to mean that the filler in question is present in the solid state of matter under usual ambient conditions, in particular at a temperature of 20° C. and at a pressure of 1.01325 bar.

The subject matter of the invention is associated with a wide variety of advantages. For instance, it enables the provision of PU, preferably PU foams, especially rigid PU foams, having high solids contents. Advantageously, this is made possible without adversely affecting the other properties of the material, in particular the mechanical properties thereof. With regard to the provision of rigid PU foams, foam structures that are particularly fine-celled, uniform and low in defects are moreover made possible. It is thus possible to provide corresponding polyurethanes having particularly good use properties and homogeneous property profile. The invention enables a particularly homogeneous distribution of solid fillers in the polyurethane. The invention overall enables easy processing of the solid fillers during production. The solid fillers can be introduced into the reaction mixture in a very simple manner, for example together with the at least one surfactant based on quaternary ammonium compounds, such as preferably ester quats and/or alkyl quats, for example via one of the two reaction components (polyol component or polyisocyanate component).

Introduction via the polyol component is preferred. Sedimentation problems during storage of the dispersion of reaction component and solid can be significantly reduced or even avoided by the present invention. The invention also permits very good redispersibility of the solid in the event of sedimentation after very long storage, which means that, for example, constant stirring or mixing during storage is no longer necessary. The invention also enables more homogeneous distribution of the solid in the polyurethane, which results in a more uniform property profile.

Surfactants based on quaternary ammonium compounds, such as ester quats, amidoamine quats, imidazolinium quats, cetylpyridinium chloride and/or alkyl quats, are known per se to those skilled in the art. For instance, e.g. ester quats and alkyl quats are surfactants based on quaternary ammonium compounds having at least one long hydrocarbon radical. Whereas alkyl quats are generally tetraalkylammonium salts, ester quats are generally based on quaternary triethanolmethylammonium compounds or quaternary diethanoldimethylammonium compounds esterified with at least one fatty acid.

Alkyl quats and ester quats have long been used in cosmetics or detergents and cleaning agents, e.g. fabric softeners, and the production thereof has long been known to those skilled in the art. Alkyl quats can be produced for example by reaction of the corresponding amine with methylating agents such as chloromethane or dimethyl sulfate. Ester quats can be produced for example by esterification of methyldiethanolamine or triethanolamine with fatty acids followed by quaternization with e.g. dimethyl sulfate or chloromethane.

US20160264711 A1 describes the use of quaternary ammonium compounds in flexible polyurethane foams for improving the compatibility of polyether polycarbonate polyols without the use of a solid filler. The use of quaternary ammonium compounds as an internal release agent in polyurethane elastomers without the use of a solid filler is described in U.S. Pat. No. 5,420,186 A.

The composition according to the invention necessarily comprises at least one solid filler, preferably selected from the group consisting of calcium carbonate, lignin, lignocellulose and plastic particles. The at least one solid filler is preferably in powder form. Mixtures of such solid fillers may also be used.

It is in accordance with a particularly preferred embodiment of the invention if the plastic particle(s) are formed from at least one plastic, preferably selected from the group consisting of polyethylene, polypropylene, polyamide (in particular PA6, PA6.6, PA10, PA11 and/or PA12), polyester (in particular polyethylene terephthalate, polybutylene terephthalate and/or poly-s-caprolactone), polystyrene, polyacrylate, polymethyl methacrylate, polycarbonate, styrene-acrylonitrile copolymers, polyether, polylactic acid, polyurethane, polysulfones, polyethersulfone, polyetherimide and polyimide, especially polyurethane.

In accordance with a particularly preferred embodiment of the invention, the plastic particle(s) can be wholly or partly formed from recycled plastics, preferably recycled polyurethanes.

According to a particularly preferred embodiment of the invention, the at least one solid filler preferably has a weight-average diameter of the primary particles, determined by means of dynamic light scattering, of >50 nm, preferably of greater than 100 nm, particularly preferably of greater than 200 nm. Determining the particle diameter by means of dynamic light scattering is known to the person skilled in the art and is preferably carried out in water.

According to a particularly preferred embodiment of the present invention, the composition according to the invention preferably does not comprise any particles of metal oxide, in particular it does not comprise any particles consisting of a material selected from the group consisting of SiO₂, ZnO₂, Al₂O₃, ZrO₂ and TiO₂.

In a particularly preferred embodiment of the invention, the surfactant(s) based on quaternary ammonium compounds preferably used are at least one ester quat of the formula (1) or (2), an alkyl quat of the formula (3), an imidazolinium quat of the formula (4), an amidoamine quat of the formula (5) and/or cetylpyridinium chloride, wherein

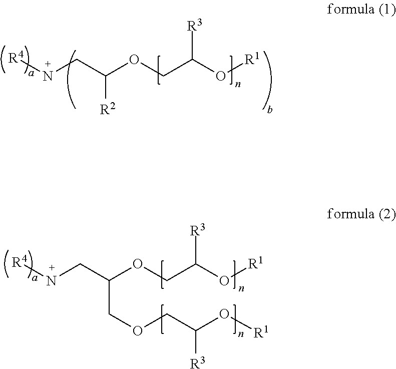

where R¹ is an acyl radical of a saturated or mono- or polyunsaturated, linear or branched fatty acid having a chain length of 8 to 22 carbon atoms or the acyl radical of ricinoleic acid, or hydrogen, 5
wherein a compound of the formula (1) or (2) may comprise different R¹ radicals and with the proviso that at least one radical R¹ must be one of the cited acyl radicals, where
R² is an alkyl radical having 1 to 6 carbon atoms or hydrogen, preferably hydrogen, methyl, ethyl, propyl or isopropyl, particularly preferably hydrogen or methyl, where
R³ is an alkyl radical having 1 to 6 carbon atoms, or hydrogen, preferably methyl, ethyl, propyl or isopropyl, particularly preferably methyl or hydrogen, where
R⁴ is an alkyl radical having 1 to 6 carbon atoms or a hydroxyethyl radical or hydrogen, preferably methyl, ethyl, propyl or isopropyl, particularly preferably ethyl or methyl, especially preferably methyl,
it being possible for a compound of the formula (1) or (2) to comprise different radicals R⁴, and where
n=0 to 20, preferably 0 to 10, particularly preferably 0,
where

$$a = 1 to 3 and$$

$$b = 1 to 3 ,$$

with the proviso that a+b=4,
and/or wherein

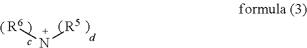

where
R⁵ is a saturated or mono- or polyunsaturated, linear or branched alkyl radical having a chain length of 8 to 24 carbon atoms,
it being possible for a compound of the formula (3) to comprise different radicals R⁵, where
R⁶ is an alkyl radical having 1 to 6 carbon atoms or a hydroxyethyl radical or a benzyl radical or hydrogen, preferably methyl, ethyl, propyl, isopropyl or benzyl, particularly preferably ethyl or methyl, especially preferably methyl,
it being possible for a compound of the formula (3) to contain different radicals R⁶, and
where

$$c = 1 to 3 and d = 1 to 3 ,$$

with the proviso that c+d=4
and/or wherein

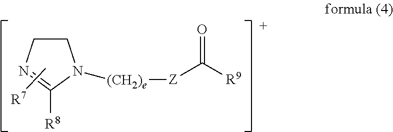

where
R⁷ is an alkyl radical having 1 to 6 carbon atoms or a hydroxyethyl radical or hydrogen, preferably methyl, ethyl, propyl or isopropyl, particularly preferably ethyl or methyl, especially preferably methyl, where
R⁸ is a saturated or mono- or polyunsaturated, linear or branched alkyl radical having 8 to 22 carbon atoms or a radical O(CO)R¹⁰, where R¹⁰ is an aliphatic, saturated or mono- or polyunsaturated, linear or branched alkyl radical having 7 to 21 carbon atoms, where
R⁹ is an aliphatic, saturated or mono- or polyunsaturated, linear or branched alkyl radical having 7 to 21 carbon atoms,
where
Z is an NH group or oxygen,
where e can be an integer between 1 and 4,
and/or wherein

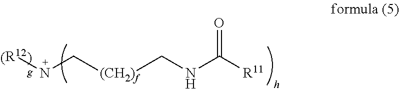

where
R¹¹ is a saturated or mono- or polyunsaturated, linear or branched alkyl radical having a chain length of 7 to 21 carbon atoms, where
R¹² is an alkyl radical having 1 to 6 carbon atoms or a hydroxyethyl radical or hydrogen, preferably methyl, ethyl, propyl or isopropyl, particularly preferably ethyl or methyl, especially preferably methyl,
it being possible for a compound of the formula (5) to comprise different radicals R¹², and where
f can be an integer between 0 and 5,
where

$$h = 1 or 2 and g = 2 or 3 ,$$

with the proviso that h+g=4,
wherein a compound of the formula (5) can have different values of f for h=2 and may comprise different radicals R¹¹, if R⁴, R⁶, R⁷ or R¹² comprises a hydroxyethyl radical, the latter may also be alkoxylated and this optionally alkoxylated hydroxyethyl radical may comprise repeating units based on ethylene oxide, propylene oxide, butylene oxide and/or styrene oxide and comprise 1-15 repeating units, preferably 1-10 repeating units.

Corresponding compositions comprising corresponding quaternary ammonium compounds show particularly advantageous results in respect of the above-described advantages of the invention.

It corresponds to a further particularly preferred embodiment of the invention when, in formula (1) and/or formula (2), R¹ is selected from the acyl radicals of the acids from the group comprising oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acid and/or cervonic acid.

It is further preferable when, in formula (1), a=b=2 and/or in formula (5), h=1 and g=3. This likewise corresponds to a further particularly preferred embodiment of the invention.

A composition according to the invention comprising at least one counteranion to the compound(s) of the general formulae (1), (2), (3), (4) and/or (5) selected from the group comprising chloride, bromide, iodide, alkyl sulfate, e.g. methyl sulfate, ethyl sulfate, alkyl sulfonate, e.g. methyl sulfonate, triflate, tosylate, phosphate, sulfate, hydrogen sulfate, lactate, glycolate, acetate and/or citrate corresponds to a further particularly preferred embodiment of the invention.

A further particularly preferred embodiment of the invention is when the at least one surfactant based on a quaternary ammonium compound is present in the composition according to the invention in a total amount of 0.1 to 10 parts by weight, preferably 0.1 to 5 parts by weight, particularly preferably 0.1 to 4 parts by weight, based on 100 parts by weight of polyols.

In a further preferred embodiment of the invention, the at least one solid filler is present in the composition according to the invention in a total amount of 1 to 80 parts by weight, preferably 5 to 60 parts by weight, particularly preferably 8 to 40 parts by weight, based on 100 parts by weight of polyols.

According to a further particularly preferred embodiment of the invention, the at least one solid filler is preferably present in the composition according to the invention in a total amount which leads to the production of PU, preferably PU foam, which comprises >2% by weight, preferably >5% by weight, more preferably >8% by weight, even more preferably >10% by weight, of the at least one solid filler, % by weight based on the resulting PU, preferably PU foam. A possible upper limit may preferably be ≤30% by weight, e.g. 15% by weight or e.g. 20% by weight.

It is additionally particularly preferable when the composition according to the invention additionally comprises at least one foam stabilizer, preferably based on a polyether siloxane, preferably in amounts of 0.5 to 4 parts by weight based on 100 parts by weight of polyols. This corresponds to a particularly preferred embodiment of the invention. Foam stabilizers, preferably based on a polyether siloxane, are known per se. Suitable foam stabilizers are described hereinbelow.

The invention further relates to a process for producing PU, preferably PU foam, especially rigid PU foam, based on reaction mixtures comprising a polyisocyanate component, a polyol component, optionally blowing agents, at least one solid filler, optionally at least one catalyst and optionally other additives, wherein at least one surfactant based on quaternary ammonium compounds is used, preferably as described above, preferably with the use of a composition of the invention as described above, in particular as described above in more detail in the preferred and/or particularly preferred embodiments.

In particular, it is preferred when the at least one surfactant based on a quaternary ammonium compound is used in a total amount of 0.1 to 10 parts by weight, preferably 0.1 to 5 parts by weight, particularly preferably 0.1 to 4 parts by weight, based on 100 parts by weight of polyols. This is in accordance with a particularly preferred embodiment of the invention.

In particular, it is preferred when the at least one solid filler is used in a total amount of 1 to 80 parts by weight, preferably 5 to 60 parts by weight, particularly preferably 8 to 40 parts by weight, based on 100 parts by weight of polyols. This is in accordance with a particularly preferred embodiment of the invention.

In particular, it is further preferred when at least one foam stabilizer, in particular one based on a polyether siloxane, is additionally present in amounts of 0.5 to 4 parts by weight, based on 100 parts by weight of polyols. This is in accordance with a particularly preferred embodiment of the invention.

Furthermore, it is in accordance with a particularly preferred embodiment of the invention when the process according to the invention for producing PU, preferably PU foam, especially rigid PU foam, is characterized in that the resulting PU, preferably PU foam, especially rigid PU foam, comprises the at least one solid filler in a total amount of >2% by weight, preferably >5% by weight, more preferably >8% by weight, even more preferably >10% by weight, % by weight based on the resulting PU, preferably PU foam, especially rigid PU foam. A possible upper limit may preferably be ≤30% by weight, e.g. 15% by weight or e.g. 20% by weight.

According to a particularly preferred embodiment of the present invention, preferably no particles of metal oxide are used in the process according to the invention, in particular no particles consisting of a material selected from the group consisting of SiO₂, ZnO₂, Al₂O₃, ZrO₂ and TiO₂.

The process according to the invention for producing PU, preferably PU foam, especially rigid PU foam, can be carried out by the known methods, for example by manual mixing or preferably by means of foaming machines. If the process is conducted using foaming machines, it is possible to use high-pressure or low-pressure machines. The process according to the invention can be carried out either batchwise or continuously.

A particularly preferred PU formulation in the context of this invention gives a foam density of 5 to 900 kg/m³ and has the composition shown in Table 1, which corresponds to a preferred embodiment of the invention:

TABLE 1
Composition of a preferred rigid PU foam formulation

| Component | Parts by weight |
|---|---|
| Polyol | >0 to 99.9 |
| Surfactant(s) based on quaternary ammonium | 0.1 to 10 |
| compounds, preferably according to formulae (1), | |
| (2), (3), (4) and/or (5) | |
| Solid filler | 1 to 80 |
| Amine catalyst | 0 to 5 |
| Metal catalyst | 0 to 10 |
| Foam stabilizer, preferably polyether siloxane | 0 to 5 |
| Water | 0 to 20 |
| Blowing agent | >0 to 40 |
| Further additives | 0 to 300 |
| Isocyanate index: 10 to 1000 | |

For further preferred embodiments and configurations of the process according to the invention, reference is also made to the details already given above in connection with the composition according to the invention.

The present invention still further provides a PU, preferably PU foam, especially a rigid PU foam, produced according to the process according to the invention specified above, in particular using a composition according to the invention.

It is a preferred embodiment of the invention when the PU according to the invention is a PU foam, especially a rigid PU foam, and has a foam density of 5 to 900 kg/m³, preferably 5 to 350 kg/m³, in particular 10 to 200 kg/m³.

In the context of a particularly preferred embodiment, the PU according to the invention, preferably PU foam, especially rigid PU foam, produced according to the process according to the invention specified above, preferably comprises the at least one solid filler in a total amount of >2% by weight, preferably >5% by weight, more preferably >8% by weight, even more preferably >10% by weight, % by weight based on the total polyurethane, preferably PU foam, especially rigid PU foam.

In the context of a particularly preferred embodiment, the PU according to the invention, preferably PU foam, especially rigid PU foam, preferably does not comprise any particles of metal oxide, in particular any particles consisting of a material selected from the group consisting of SiO₂, ZnO₂, Al₂O₃, ZrO₂ and TiO₂.

The present invention further relates to the use of PU and/or PU foam according to the invention, as mentioned above, as refrigerator insulation, as construction material, preferably as insulation panel, sandwich element, spray foam and/or 1- and 1.5-component can foam, as pipe insulation, imitation wood, modelling foam, packaging foam, mattress, furniture cushioning, automotive seat cushioning, headrest, instrument panel, automotive interior trim, automotive roof liner, sound absorption material, steering wheel, shoe sole, carpet backing foam, filter foam, sealing foam, sealant, adhesive or coating, or for production of corresponding products.

A preferred composition according to the invention comprises in particular the following constituents:
a) surfactant(s) based on quaternary ammonium compounds, in particular as defined above by formulae (1), (2), (3), (4) and/or (5)
b) polyol component
c) polyisocyanate component
d) catalyst
e) optionally foam stabilizers
f) optionally one or more blowing agents
g) solid filler(s)
h) optionally further additives, flame retardants, etc.

The polyol component (b) consists of at least one polyol and optionally at least one organic compound comprising at least two isocyanate-reactive groups, preferably selected from the group consisting of OH, NH and NH₂ groups. Polyols are organic compounds comprising at least two hydroxyl groups (—OH).

If one of the aforementioned organic compounds of the polyol component comprises at least two OH groups then, in the context of the invention, this is attributed exclusively to the polyols. This means that if an organic compound of the polyol component can be classified both as a polyol and as an organic compound comprising at least two isocyanate-reactive groups, preferably selected from the group consisting of OH, NH and NH₂ groups, it is attributed exclusively to the polyols in the context of the invention.

Based on the total weight thereof, the polyol component preferably comprises at least 50% by weight of such polyols comprising only hydroxyl groups (—OH) as isocyanate-reactive groups.

Based on the total number of isocyanate-reactive groups of the polyol component, it is preferable that at least 50% of these are hydroxyl groups (—OH).

Appropriate compounds which may typically be used when producing PU foams are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to use compounds having OH numbers within a range from 10 to 1200 mg KOH/g.

Particularly preferred compounds are all polyether polyols and polyester polyols typically used for production of polyurethane systems, especially polyurethane foams. Polyether polyols can be obtained preferably by reacting polyhydric alcohols or amines with alkylene oxides. Polyester polyols are preferably based on esters of polyvalent carboxylic acids (which may be either aliphatic, for example adipic acid, or aromatic, for example phthalic acid or terephthalic acid) with polyhydric alcohols (for example glycols).

In addition, it is possible to use polyether polycarbonate polyols, polyols based on natural oils (natural oil based polyols, NOPs; described in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis. The use of recycled polyols constitutes a particularly preferred embodiment of the invention.

The polyisocyanate component (c) consists of at least one polyisocyanate having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se.

Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”).

The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible.

The mixture of MDI and more highly condensed analogues having an average functionality of 2 to 4 which is known as polymeric MDI (also referred to as “crude MDI”) is particularly suitable, as well as the various isomers of TDI in pure form or as isomeric mixture.

It is also possible to use isocyanates which have been modified by the incorporation of urethane, uretdione, isocyanurate, allophanate and other groups, known as modified isocyanates. Examples of particularly suitable isocyanates are also detailed for example in EP 1712578, EP 1161474, WO 00/58383, US 2007/0072951, EP 1678232 and WO 2005/085310, which are hereby fully incorporated by reference.

A preferred ratio of polyisocyanate component and polyol component, expressed as the index of the formulation (isocyanate index), i.e. as stoichiometric ratio of isocyanate groups to isocyanate-reactive groups (e.g. OH groups, NH groups) multiplied by 100, is in the range from 10 to 1000 and preferably from 40 to 400. An index of 100 represents a molar ratio of reactive groups of 1:1.

Suitable catalysts (d) which can be used for the production of polyurethanes, in particular PU foams, and in particular are capable of catalysing the formation of a urethane or isocyanurate linkage, are known to those skilled in the art from the prior art. Compounds that can be used in the context of the present invention are in particular all compounds capable of catalysing the reaction of isocyanate groups with OH groups, NH groups or other isocyanate-reactive groups, and/or the reaction of isocyanate groups with one another.

It is possible to employ here the customary catalysts known from the prior art, including for example amines (cyclic, acyclic; monoamines, diamines, oligomers having one or more amino groups), ammonium compounds, organometallic compounds and/or metal salts, preferably those of tin, iron, bismuth, potassium and/or zinc. In particular, catalysts used may be mixtures of two or more compounds of this kind.

Foam stabilizers (e) and the use thereof in the production of PU foams are known to those skilled in the art. The use of foam stabilizers is optional; preference is given to using one or more foam stabilizers. They may be used to optimize the desired cell structure and the foaming process.

In the context of the present invention, it is possible in particular to use Si-containing compounds that assist foam production (stabilization, cell regulation, cell opening, etc.). These compounds are sufficiently well known from the prior art. Particular preference is given to using at least one foam stabilizer based on a polyether siloxane.

Corresponding siloxane structures employable for the purposes of the present invention are described for example in the following patent documents, although these describe use only in conventional PU foams, as moulded foam, mattress, insulation material, construction foam, etc.: CN 103665385, CN 103657518, CN 103055759, CN 103044687, US 2008/0125503, US 2015/0057384, EP 1520870 A1, EP 1211279, EP 0867464, EP 0867465, EP 0275563. As well as surface-active Si-containing compounds, Si-free surfactants may also be used. For example, EP2295485 A1 describes the use of lecithin and U.S. Pat. No. 3,746,663 the use of vinylpyrrolidone-based structures as foam stabilizer for the production of rigid PU foam. Further Si-free foam stabilizers are described for example in EP 2511328 B1, DE 1020011007479 A1, DE 3724716 C1, EP 0734404, EP 1985642, DE 2244350 and U.S. Pat. No. 5,236,961.

Blowing agents (f) and the use thereof in the production of PU foams are known to those skilled in the art. The use of blowing agents is optional; preference is given to using blowing agents. The use of a blowing agent (f) or of a combination of two or more blowing agents (f) depends in principle on the nature of the foaming process used, on the nature of the system and on the use for the PU foam obtained.

Chemical and/or physical blowing agents may be used, as well as a combination of the two. Depending on the amount of blowing agent used, a foam having high or low density is produced. For instance, foams can be produced having densities of 5 kg/m³ to 900 kg/m³, preferably 5 to 350 kg/m³, particularly preferably 8 to 200 kg/m³, especially 8 to 150 kg/m³.

Physical blowing agents that may be used are one or more of the appropriate compounds having suitable boiling points and mixtures thereof, for example hydrocarbons having 3, 4 or 5 carbon atoms, preferably cyclo-, iso-, n-pentane, hydrofluorocarbons (HFCs), preferably HFC 245fa, HFC 134a or HFC 365mfc, hydrochlorofluorocarbons (HCFCs), preferably HCFC 141b, hydrofluoroolefins (HFOs) or hydrohaloolefins, preferably 1234ze, 1234yf, 1224 yd, 1233zd (E) or 1336mzz, esters, preferably methyl formate, ketones, preferably acetone, ethers, preferably dimethoxymethane, or chlorinated hydrocarbons, preferably dichloromethane or 1,2-dichloroethane.

Chemical blowing agents used may be one or more compounds that react with NCO groups with the release of gases, for example water or formic acid, or which release gases during the reaction as a result of the rise in temperature, for example sodium hydrogencarbonate.

It is a particularly preferred embodiment when the composition according to the invention comprises, as blowing agent, water in combination with hydrocarbons having 5 carbon atoms, HFOs, hydrohaloolefins or HFCs or mixtures thereof.

Solid fillers g) have already been described above.

Optional additives (h) used may be one or more of the substances which are known from the prior art and are used in the production of polyurethanes, especially PU foams, for example crosslinkers, chain extenders, stabilizers against oxidative degradation (known as antioxidants), flame retardants, biocides, cell-refining additives, nucleating agents, cell openers, antistatic additives, thickeners, dyes, pigments, colour pastes, fragrances, and/or emulsifiers etc.

As optional flame retardant, the composition according to the invention may comprise one or more of the known flame retardants suitable for production of PU foams, for example halogen-containing or halogen-free organic phosphorus-containing compounds, for example triethyl phosphate (TEP), tris(1-chloro-2-propyl) phosphate (TCPP), tris(2-chloroethyl) phosphate (TCEP), dimethyl methanephosphonate (DMMP), dimethyl propanephosphonate (DMPP), ammonium polyphosphate or red phosphorus, nitrogen-containing compounds, for example melamine, melamine cyanurate or melamine polyphosphate, or halogenated compounds, for example chlorinated and/or brominated polyether polyols and/or polyester polyols. It is also possible to use mixtures of different flame retardants.

Unless the opposite is apparent from this description, it is possible to combine any preferred or particularly preferred embodiment of the invention with one or more of the other preferred or particularly preferred embodiments of the invention.

The subject matter of the invention was and is described by way of example hereinbelow, without any intention that the invention be restricted to these illustrative embodiments. Where ranges, general formulae or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are in weight percent. Where average values are stated, these are weight averages unless stated otherwise. Where parameters which have been determined by measurement are reported, the measurements have been carried out at a temperature of 25° C. and a pressure of 101 325 Pa (standard pressure), unless stated otherwise.

The examples that follow describe the present invention by way of example without any intention to limit the invention, the scope of application of which is apparent from the entirety of the description and the claims, to the embodiments specified in the examples.

### EXAMPLES

### Example 1: PIR Rigid Foam (PIR=Polyisocyanurate)

For the application-specific comparison, the formulation shown in Table 2 was used and the compounds shown in Table 3 were investigated. The comparative foaming operations were carried out by manual mixing. For this purpose, polyol, catalysts, water, foam stabilizer, dispersant (Table 3), solid filler and blowing agent were weighed into a beaker and mixed with a disc stirrer (diameter 6 cm) at 1000 rpm for 30 s (batch size 500 g). The beaker was reweighed to determine the amount of blowing agent that had evaporated during the mixing operation and this was replenished. The MDI was then added, and the reaction mixture stirred with the described stirrer at 3000 rpm for 5 s and immediately transferred to a 25 cm×50 cm×7 cm aluminium mould lined with polyethylene film and thermostatted to 60° C.

After 10 min, the foams were demoulded. One day after foaming, the foams were analysed. Surface and internal defects were assessed subjectively on a scale from 1 to 10, where 10 represents an (idealized) defect-free foam and 1 represents a very significantly defective foam. The thermal conductivity coefficient (λ value in mW/m·K) was measured on 2.5 cm-thick discs with an instrument of the Hesto Lambda Control type, model HLC X206, at an average temperature of 10° C. in accordance with the specifications of standard EN12667:2001.

TABLE 2
Rigid PIR foam formulation

| Component | Parts by weight |
|---|---|
| Polyester polyol* | 100 |
| Amine catalyst** | 0.6 |
| Potassium trimerization catalyst*** | 4 |
| Foam stabilizer**** | 2 |
| Water | 0.8 |
| Inventive compound | 0/0.5 |
| Solid filler***** | 10 |
| Cyclopentane/isopentane 70:30 | 18 |
| MDI****** | 286 |

*Stepanpol ® PS 3152 from Stepan, OH value 315 mg KOH/g
**POLYCAT ® 5 from Evonik Operations GmbH
***DABCO ® TMR 12 from Evonik Operations GmbH
****TEGOSTAB ® B 84504 from Evonik Operations GmbH
*****Lignin from hardwood, CaCO₃, PIR powder or PUR powder
******Polymeric MDI, 200 mPa*s, 31.5% NCO, functionality 2.7.

TABLE 3
Compounds investigated

| Name | Type | Composition |
|---|---|---|
| Ester quat EQ 1 | Ester quat | Dimethyl, diisopropyl ester of isostearic |
| | | acid and oleic acid (methylsulfate) |
| Ester quat EQ 2 | Ester quat | Methyl, hydroxyethyl, dihydroxyethyl |
| | | oleate ester quat (methylsulfate) |
| Ester quat EQ 3 | Ester quat | Methyl, hydroxyethyl, dihydroxyethyl |
| | | tallowate ester quat (methylsulfate) |
| Ester quat EQ 4 | Ester quat | Methyl, hydroxyethyl, dihydroxyethyl |
| | | palmeate ester quat (methylsulfate) |
| Ester quat EQ 5 | Ester quat | Dimethyl, dihydroxyethyl tallowate ester |
| | | quat (chloride) |
| Alkyl quat AQ 1 | Alkyl quat | Behenyl (C22) trimethylammonium |
| | | chloride |
| Alkyl quat AQ 2 | Alkyl quat | Distearyl dimethylammonium chloride |
| Alkyl quat AQ 3 | Alkyl quat | Ethyl bis(polyethylene |
| | | glycol)tallylammonium ethylsulfate |
| | | (Total 10 EO units) |
| Alkyl quat AQ 4 | Alkyl quat | Methyl bis(polyethylene oxide)coco- |
| | | ammonium chloride |
| | | (Total 15 EO units) |
| Alkyl quat AQ 5 | Alkyl quat | Methyl bis(polyethylene oxide)coco- |
| | | ammonium methylsulfate |
| | | (Total 5 EO units) |
| Imidazolinium quat IQ 1 | Imidazolinium | Dioleyl imidazolinium quat |
| | quats | (methylsulfate, R⁷ = methyl, e = 2, Z = N) |
| Imidazolinium quat IQ 2 | Imidazolinium | Dipalmityl imidazolinium quat |
| | quats | (methylsulfate, R⁷ = methyl, e = 2, Z = N) |
| Amidoamine quat | Amidoamine quat | Methyl, polyethylene oxide, dipalm |
| AmQ1 | | stearin amidoamine quat |
| | | (f = 0, 3.5 EO, methylsulfate) |
| Amidoamine quat | Amidoamine quat | Methyl, polyethylene oxide, diisostearin |
| AmQ2 | | amidoamine quat |
| | | (f = 0, 3.0 EO, methylsulfate) |
| Cetylpyridinium | — | — |
| chloride | | |
| TEGOPREN ® 6921 | Silicone quat | non-inventive |
| TEGOTEX ® 8080 | Silicone quat | non-inventive |
| TEGO ® Dispers 652 | Modified | non-inventive |
| | derivatives based | |
| | on tallow oil | |
| Thixatrol ® ST | Modified | non-inventive |
| | derivatives based | |
| | on castor oil | |

The compounds according to the invention were compared with non-inventive, commercially available surfactants (TEGOPREN® 6921, TEGOTEX® 8080, TEGO® Dispers 652, Thixatrol® ST).

The results are compiled in Tables 4 and 5:

TABLE 4
Foam properties of rigid PIR foam with lignin as filler

| | | | | Cell |
|---|---|---|---|---|
| | Density | λ value | Cell | structure |
| | in kg/ | in mW/ | structure | internal |
| Compound | m³ | m · K | surface | defects |
| Without dispersant | 38.4 | 23.2 | 6.0 | 6.5 |
| additive | | | | |
| Ester quat EQ 1 | 38.2 | 22.4 | 7.0 | 7.0 |
| Ester quat EQ 2 | 37.7 | 22.9 | 6.5 | 7.5 |
| Ester quat EQ 3 | 38.7 | 23.0 | 7.5 | 7.0 |
| Ester quat EQ 4 | 38.3 | 22.8 | 7.0 | 7.0 |
| Ester quat EQ 5 | 38.0 | 22.7 | 6.5 | 7.0 |
| Alkyl quat AQ 1 | 38.1 | 23.4 | 6.5 | 6.5 |
| Alkyl quat AQ 2 | 37.9 | 22.9 | 7.5 | 8.0 |
| Alkyl quat AQ 3 | 38.1 | 22.8 | 6.0 | 6.5 |
| Alkyl quat AQ 4 | 38.4 | 23.1 | 4.0 | 7.0 |
| Alkyl quat AQ 5 | 38.1 | 23.0 | 7.5 | 7.0 |
| Imidazolinium quat IQ 1 | 37.8 | 23.1 | 6.5 | 7.5 |
| Imidazolinium quat IQ 2 | 38.3 | 22.8 | 7.0 | 7.0 |
| Amidoamine quat AmQ1 | 37.8 | 23.4 | 7.5 | 7.0 |
| Amidoamine quat AmQ2 | 37.6 | 23.0 | 6.5 | 7.0 |
| Cetylpyridinum chloride | 38.8 | 22.9 | 6.5 | 6.5 |
| TEGOPREN ® 6921 | — | — | 2.0 (highly | 1.0 (highly |
| | | | disrupted) | disrupted) |
| TEGOTEX ® 8080 | — | — | collapse | collapse |
| TEGO ® Dispers 652 | 38.6 | 23.6 | 5.5 | 6.0 |
| Thixatrol ® ST | 38.7 | 23.8 | 5.0 | 6.0 |

TABLE 5
Cell structure surface/internal defects for rigid PIR foam

| Compound | CaCO₃ | PIR powder | PUR powder |
|---|---|---|---|
| Without dispersant | 6.5/6.5 | 5.5/5.0 | 5.5/5.0 |
| additive | | | |
| Ester quat EQ 1 | 7.0/6.5 | 6.0/6.0 | 6.0/6.0 |
| Ester quat EQ 2 | 7.0/7.0 | 6.0/6.0 | 6.0/6.0 |
| Ester quat EQ 3 | 6.5/6.5 | 6.0/6.0 | 6.5/6.0 |
| Ester quat EQ 4 | 7.5/7.0 | 5.5/6.0 | 5.5/6.0 |
| Ester quat EQ 5 | 7.0/7.0 | 6.5/5.5 | 6.5/6.5 |
| Alkyl quat AQ 1 | 7.5/7.5 | 6.5/6.0 | 6.5/6.5 |
| Alkyl quat AQ 2 | 7.5/7.0 | 6.0/6.0 | 6.0/6.5 |
| Alkyl quat AQ 3 | 6.5/7.5 | 6.5/6.5 | 6.0/6.5 |
| Alkyl quat AQ 4 | 5.5/7.0 | 4.5/6.0 | 5.0/6.0 |
| Alkyl quat AQ 5 | 6.5/6.5 | 5.5/5.0 | 5.5/5.0 |
| Imidazolinium quat IQ | 7.0/7.0 | 6.5/6.5 | 6.5/6.5 |
| 1 | | | |
| Imidazolinium quat IQ | 7.0/7.5 | 6.5/6.5 | 6.5/6.5 |
| 2 | | | |
| Amidoamine quat | 6.5/7.5 | 7.0/6.5 | 7.0/6.5 |
| AmQ1 | | | |
| Amidoamine quat | 6.5/6.0 | 6.5/6.0 | 6.5/6.0 |
| AmQ2 | | | |
| Cetylpyridinum | 6.0/6.5 | 5.5/5.0 | 5.0/5.0 |
| chloride | | | |

| | |
|---|---|
| TEGOPREN ® 6921 | highly disrupted |
| TEGOTEX ® 8080 | collapse |

| | | | |
|---|---|---|---|
| TEGO ® Dispers 652 | 6.0/6.5 | 5.5/5.0 | 5.5/5.0 |
| Thixatrol ® ST | 6.5/6.5 | 6.0/4.5 | 6.0/5.0 |

The results show that the relevant foam properties are affected only negligibly or not at all by the compounds according to the invention. Through the use of the compounds according to the invention, it is moreover possible to achieve a more homogeneous distribution of the solid filler in the foam, which is manifested both in a significant improvement in the surface and in pore structure/internal defects. The non-inventive compounds, in contrast, frequently result in high coarsening of the foam (TEGOPREN® 6921), to collapse (TEGOTEX® 8080) or show no improvement in the foam structure (TEGO® Dispers 652, Thixatrol® ST).

### Example 2: Dispersion Behaviour

For the application-specific comparison, the formulations shown in Tables 6, 8, 10 and 12 were used and the compounds shown in Table 3 were investigated. For this purpose, polyol and water were weighed out (batch size 100 g) and mixed with a disc stirrer (diameter 6 cm) at 1000 rpm for 30 s. The compound according to the invention was then added and mixed in with a disc stirrer (diameter 6 cm) at 2000 rpm for 30 s. For the reference experiment, the same mixture without addition of the compound according to the invention was likewise mixed at 2000 rpm for a further 30 s. The solid filler was then added with the disc stirrer still running at 2000 rpm and mixed in for a further 45 s. The formulations were then transferred to glass vessels, sealed and the time until complete sedimentation measured.

After storage upright for 14 days at room temperature, all samples were redispersed and redispersibility was evaluated using a scale of 1 to 3. In this scale, a score of 1 means that the sample could already be brought back into dispersion by manually shaking the glass vessel for 30 s. A score of 2 means that, although not possible by manual shaking, the sample could be redispersed using an electric laboratory stirrer (500 rpm for 60 s). A score of 3 was awarded to samples in which a very fine, compact sediment had formed that could not be redispersed by the two methods mentioned above.

The viscosity was determined using two measuring methods. Either the viscosities were measured at different shear rates on freshly prepared formulations (Table 5) with the aid of an Anton Paar MCR 302 rheometer (50 mm plate-plate, 0.5 mm gap) at 25° C., or measured at different shear rates on freshly prepared formulations with the aid of a DV2 T rheometer using spindles of LV04 (64) type at 21° C.

The results for the dispersion behaviour are shown in Tables 7, 9, 11 and 13.

TABLE 6
Formulation for testing dispersion behaviour

| Component | Parts by weight |
|---|---|
| Polyester polyol* | 100 |
| Water | 0.8 |
| Inventive compound | 0.5 |
| Solid filler** | 10 |

*Stepanpol ® PS 3152 from Stepan, OH value 315 mg KOH/g
**Lignin from hardwood

TABLE 7
Dispersion behaviour - Lignin from hardwood

| | Sedimenta- | | Viscosity | Viscosity |
|---|---|---|---|---|
| | tion | Redispers- | at 0.2 1/s | at 100 1/s |
| Compound | stability | ibility | in Pa*s* | in Pa*s* |
| Without dispersant | 24 h | 2 | 7.6 | 3.8 |
| additive | | | | |
| Ester quat EQ 1 | 36 h | 1 | 3.8 | 3.2 |
| Ester quat EQ 2 | 36 h | 1 | 7.9 | 3.5 |
| Ester quat EQ 3 | 36 h | 1 | 4.8 | 3.9 |
| Ester quat EQ 4 | 36 h | 1 | 5.1 | 3.8 |
| Ester quat EQ 5 | 48 h | 1 | 5.0 | 3.7 |
| Alkyl quat AQ 1 | 32 h | 1 | 5.3 | 3.6 |
| Alkyl quat AQ 2 | 32 h | 1 | 5.7 | 3.3 |
| Alkyl quat AQ 3 | 32 h | 1 | 4.3 | 3.2 |
| Alkyl quat AQ 4 | 32 h | 1 | 4.9 | 3.8 |
| Alkyl quat AQ 5 | 32 h | 1 | 5.0 | 4.0 |
| Imidazolinium quat | 48 h | 1 | 7.5 | 3.8 |
| IQ 1 | | | | |
| Imidazolinium quat | 36 h | 1 | 7.9 | 3.4 |
| IQ 2 | | | | |
| Amidoamine quat | 48 h | 1 | 4.8 | 3.9 |
| AmQ1 | | | | |
| Amidoamine quat | 32 h | 1 | 7.3 | 3.3 |
| AmQ2 | | | | |
| Cetylpyridinum | 36 h | 1 | 4.4 | 3.4 |
| chloride | | | | |
| TEGOPREN ® 6921 | Not tested due to severe disruption of the foam | | | |
| TEGOTEX ® 8080 | Not tested due to severe disruption of the foam | | | |
| TEGO ® Dispers 652 | 18 h | 1 | 8.3 | 3.7 |
| Thixatrol ® ST | 24 h | 2 | 10.3 | 3.8 |

*Cone/plate rheometer

TABLE 8
Formulation for testing the dispersion behaviour

| Component | Parts by weight |
|---|---|
| Polyester polyol* | 100 |
| Water | 0.8 |
| Inventive compound | 5 |
| Solid filler** | 8 |

*Stepanpol ® PS 3152 from Stepan, OH value 315 mg KOH/g
**CaCO₃.

TABLE 9
Dispersion behaviour - CaCO₃

| | Sedimentation | |
|---|---|---|
| Compound | stability | Redispersibility |
| Without dispersant | 12 h | 2 |
| additive | | |
| Ester quat EQ 1 | >7 d | 1 |
| Ester quat EQ 2 | >7 d | 1 |
| Ester quat EQ 3 | 56 h | 1 |
| Ester quat EQ 4 | 36 h | 1 |
| Ester quat EQ 5 | 56 h | 1 |
| Alkyl quat AQ 1 | 48 h | 1 |
| Alkyl quat AQ 2 | 12 h | 1 |
| Alkyl quat AQ 3 | 12 h | 1 |
| Alkyl quat AQ 4 | 72 h | 1 |
| Alkyl quat AQ 5 | 24 h | 2 |
| Imidazolinium quat IQ 1 | 24 h | 2 |
| Imidazolinium quat IQ 2 | 48 h | 2 |
| Amidoamine quat | 48 h | 1 |
| AmQ1 | | |
| Amidoamine quat | >7 d | 1 |
| AmQ2 | | |
| Cetylpyridinum chloride | 24 h | 1 |

| | |
|---|---|
| TEGOPREN ® 6921 | Not tested due to severe disruption of |
| | the foam |
| TEGOTEX ® 8080 | Not tested due to severe disruption of |
| | the foam |

| | | |
|---|---|---|
| TEGO ® Dispers 652 | 48 h | 1 |
| Thixatrol ® ST | 24 h | 2 |

TABLE 10
Formulation for testing the dispersion behaviour

| Component | Parts by weight |
|---|---|
| Polyester polyol* | 100 |
| Water | 0.8 |
| Inventive compound | 0.5 |
| Solid filler** | 10 |

*Stepanpol ® PS 3152 from Stepan, OH value 315 mg KOH/g
**PIR foam insulation panel milled using a pinned disk mill (cryogenic milling with liquid nitrogen, peripheral speed 120 m/s).

TABLE 11
Dispersion behaviour - PIR powder

| | Sedimenta- | | | Viscosity | Viscosity |
|---|---|---|---|---|---|
| | tion | | Redispers- | at 1 rpm | at 5 rpm |
| Compound | stability | | ibility | in Pa*s | in Pa*s |
| Without dispersant | 6 | h | 2 | 300 | 76 |
| additive | | | | | |
| Ester quat EQ 1 | 12 | h | 2 | 274 | 67 |
| Ester quat EQ 2 | 72 | h | 2 | 240 | 90 |
| Ester quat EQ 3 | 72 | h | 2 | 250 | 85 |
| Ester quat EQ 4 | 72 | h | 2 | 224 | 92 |
| Ester quat EQ 5 | 24 | h | 2 | 146 | 67 |
| Alkyl quat AQ 1 | 6 | h | 2 | 125 | 73 |
| Alkyl quat AQ 2 | 6 | h | 2 | 200 | 71 |
| Alkyl quat AQ 3 | 6 | h | 2 | 117 | 70 |
| Alkyl quat AQ 4 | 6 | h | 2 | 130 | 72 |
| Alkyl quat AQ 5 | 6 | h | 2 | 130 | 71 |
| Imidazolinium quat | 24 | h | 2 | 129 | 82 |
| IQ 1 | | | | | |
| Imidazolinium quat | 24 | h | 2 | 140 | 80 |
| IQ 2 | | | | | |
| Amidoamine quat | 72 | h | 2 | 220 | 96 |
| AmQ1 | | | | | |
| Amidoamine quat | 24 | h | 2 | 185 | 85 |
| AmQ2 | | | | | |
| Cetylpyridinum | 6 | h | 2 | 162 | 89 |
| chloride | | | | | |

Viscosities measured with LV04 (64) type spindles

TABLE 12
Formulation for testing the dispersion behaviour

| Component | Parts by weight |
|---|---|
| Polyester polyol* | 100 |
| Water | 0.8 |
| Inventive compound | 0.5 |
| Solid filler** | 10 |

*Stepanpol ® PS 3152 from Stepan, OH value 315 mg KOH/g
**PUR foam insulation panel milled using a pinned disk mill (cryogenic milling with liquid nitrogen, peripheral speed 120 m/s).

TABLE 13
Dispersion behaviour - PUR powder

| | Sedimenta- | | Viscosity | Viscosity |
|---|---|---|---|---|
| | tion | Redispers- | at 1 rpm | at 5 rpm |
| Compound | stability | ibility | in Pa*s | in Pa*s |
| Without dispersant | 12 h | 2 | 118 | 54 |
| additive | | | | |
| Ester quat EQ 1 | 24 h | 2 | 117 | 53 |
| Ester quat EQ 2 | 24 h | 2 | 107 | 47 |
| Ester quat EQ 3 | 24 h | 2 | 98 | 40 |
| Ester quat EQ 4 | 24 h | 2 | 126 | 47 |
| Ester quat EQ 5 | 72 h | 2 | 207 | 59 |
| Alkyl quat AQ 1 | 24 h | 2 | 141 | 68 |
| Alkyl quat AQ 2 | 24 h | 2 | 312 | 101 |
| Alkyl quat AQ 3 | 24 h | 2 | 155 | 70 |
| Alkyl quat AQ 4 | 24 h | 2 | 133 | 58 |
| Alkyl quat AQ 5 | 24 h | 2 | 145 | 69 |
| Imidazolinium quat | 24 h | 2 | 165 | 69 |
| IQ 1 | | | | |
| Imidazolinium quat | 72 h | 2 | 162 | 66 |
| IQ 2 | | | | |
| Amidoamine quat | 48 h | 2 | 114 | 56 |
| AmQ1 | | | | |
| Amidoamine quat | 24 h | 2 | 118 | 46 |
| AmQ2 | | | | |
| Cetylpyridinum | 12 h | 2 | 174 | 78 |
| chloride | | | | |

Viscosities measured with LV04 (64) type spindles

In all cases investigated, an improvement in sedimentation stability and/or redispersibility was achieved compared to formulations without compounds according to the invention.

In particular, the formation of a solid, compact sediment could be avoided. The invention therefore permits very good redispersibility of the solid in the event of sedimentation after very long storage so that, for example, constant stirring or mixing during storage is no longer necessary.

1-17. (canceled)

18. A composition for producing polyurethane (PU), comprising a polyisocyanate component, a polyol component, and at least one solid filler, wherein the composition comprises at least one surfactant based on a quaternary ammonium compound.

19. The composition of claim 18, wherein said composition is a rigid PU foam and further comprises blowing agents; at least one catalyst that catalyses the formation of a urethane or isocyanurate linkage; and wherein the quaternary ammonium compound is silicon-free.

20. The composition of claim 18, wherein the at least one solid filler is selected from the group consisting of: calcium carbonate, lignin, lignocellulose, plastic particles, and combinations thereof.

21. The composition of claim 20, wherein the at least one solid filler comprises plastic particles formed from the group consisting of: polyethylene, polypropylene, polyamide, polyester, polystyrene, polyacrylate, polymethyl methacrylate, polycarbonate, styrene-acrylonitrile copolymers, polyether, polylactic acid, polyurethane, polysulfones, polyethersulfone, polyetherimide, polyimide, and combinations thereof.

22. The composition of claim 21, wherein the plastic particles are formed wholly or partly from recycled plastics.

23. The composition of claim 18, wherein the composition comprises, as solid filler, lignin, and/or plastic particles.

24. The composition of claim 18, wherein the at least one solid filler has a weight-average diameter of primary particles, determined by dynamic light scattering, of >50 nm.

25. The composition of claim 18, wherein the quaternary ammonium compound used is at least one ester quat of formula (1) or (2), an alkyl quat of formula (3), an imidazolinium quat of formula (4), an amidoamine quat of formula (5) and/or cetylpyridinium chloride, wherein formula (1) and formula (2) are as follows: 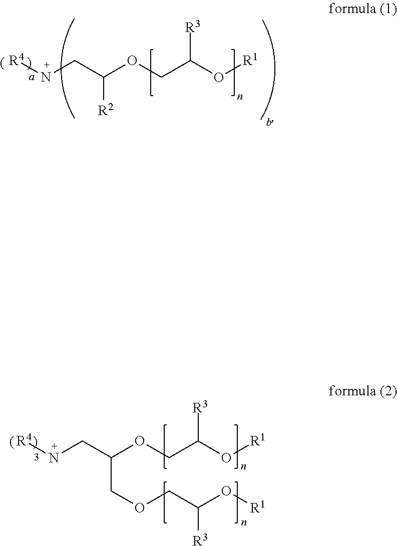
wherein:
R¹ is an acyl radical of a saturated or mono- or polyunsaturated, linear or branched fatty acid having a chain length of 8 to 22 carbon atoms or the acyl radical of ricinoleic acid, or hydrogen; and
wherein a compound of formula (1) or (2) may comprise different radicals R¹, with the proviso that at least one radical R¹ must be an acyl radical;
R² is an alkyl radical having 1 to 6 carbon atoms or hydrogen;
R³ is an alkyl radical having 1 to 6 carbon atoms or hydrogen;
R⁴ is an alkyl radical having 1 to 6 carbon atoms, a hydroxyethyl radical or hydrogen, wherein a compound of formula (1) or (2) to may comprise different radicals R⁴;
$$n = 0 to 20 ;$$
$$a = 1 to 3 and b = 1 to 3 ;$$
with the proviso that a+b=4;
wherein formula 3 is as follows: 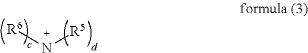
wherein:
R⁵ is a saturated, or mono- or polyunsaturated, linear or branched alkyl radical having a chain length of 8 to 24 carbon atoms, wherein a compound of formula (3) may comprise different radicals R⁵;
R⁶ is an alkyl radical having 1 to 6 carbon atoms, a hydroxyethyl radical or a benzyl radical or hydrogen, wherein a compound of the formula (3) may comprise different radicals R⁶;
$$c = 1 to 3 and d = 1 to 3 ;$$
with the proviso that c+d=4;
and wherein formula (4) is as follows: 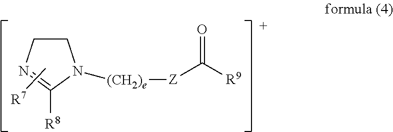
wherein:
R⁷ is an alkyl radical having 1 to 6 carbon atoms, a hydroxyethyl radical or hydrogen;
R⁸ is a saturated or mono- or polyunsaturated, linear or branched alkyl radical having 8 to 22 carbon atoms or a radical O(CO)R¹⁰, wherein R¹⁰ is an aliphatic, saturated or mono- or polyunsaturated, linear or branched alkyl radical having 7 to 21 carbon atoms;
R⁹ is an aliphatic, saturated or mono- or polyunsaturated, linear or branched alkyl radical having 7 to 21 carbon atoms;
Z is an NH group or oxygen;
e is an integer between 1 and 4,
and wherein formula (5) is as follows: 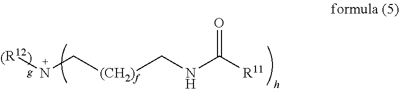
wherein:
R¹¹ is a saturated or mono- or polyunsaturated, linear or branched alkyl radical having a chain length of 7 to 21 carbon atoms;
R¹² is an alkyl radical having 1 to 6 carbon atoms, a hydroxyethyl radical or hydrogen, wherein a compound of formula (5) may comprise different radicals R¹²;
f can be an integer between 0 and 5,
$$h = 1 or 2 and$$
$$g = 2 or 3 ,$$
with the proviso that h+g=4,
wherein a compound of the formula (5) can have different values of f for h=2; may comprise different radicals R¹¹, if R⁴, R⁶, R⁷ or R¹²; may comprise a hydroxyethyl radical which is optionally alkoxylated wherein the alkoxylated hydroxyethyl radical may comprise repeating units based on ethylene oxide, propylene oxide, butylene oxide and/or styrene oxide and comprise 1-15 repeating units.

26. The composition of claim 25, wherein: R², R³, R⁴, R⁶, R⁷ and R¹² are independently hydrogen, methyl, ethyl, propyl or isopropyl and n=0-10.

27. The composition of claim 25, wherein: R², R³, R⁴, R⁶, R⁷ and R¹² are independently hydrogen or methyl and n=0.

28. The composition of claim 25, wherein, in formula (1) and/or formula (2), R¹ is selected from the acyl radicals of the acids selected from the group consisting of: oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acid, cervonic acid and combinations thereof.

29. The composition of claim 25, wherein, in formula (1), a=b=2 and/or, in formula (5), h=1 and g=3.

30. The composition of claim 25, wherein said composition further comprises at least one counter anion to the compounds of general formulae (1), (2), (3), (4) and/or (5) selected from the group consisting of: chloride, bromide, iodide, alkyl sulfate, triflate, tosylate, phosphate, sulfate, hydrogen sulfate, lactate, glycolate, acetate, citrate, and combinations thereof.

31. The composition of claim 18, wherein the at least one surfactant based on a quaternary ammonium compound is present in a total amount of 0.1 to 10 parts by weight, based on 100 parts by weight of polyols.

32. The composition of claim 31, wherein the at least one surfactant based on a quaternary ammonium compound is present in a total amount 0.1 to 4 parts by weight, based on 100 parts by weight of polyols.

33. The composition of claim 18, wherein the at least one solid filler is present in a total amount of 1 to 80 parts by weight, based on 100 parts by weight of polyols.

34. The composition of claim 33, wherein the at least one solid filler is present in a total amount of 8 to 40 parts by weight, based on 100 parts by weight of polyols.

35. The composition of claim 18, wherein at least one foam stabilizer, is additionally present an amount of 0.5 to 4 parts by weight, based on 100 parts by weight of polyols.

36. The composition of claim 18, wherein the composition does not comprise any particles of metal oxide.

37. A process for producing PU using the composition of claim 18.
